(19) United States
(12) Patent Application Publication
(10) Pub. No.: US 2010/0307170 A1
(43) Pub. Date: Dec. 9, 2010

(54) Cryogenically treated wooden baseball bat

(76) Inventors: Gregory Dean Kendra, Conifer, CO (US); James Cortez, Brookfield, IL (US)

Correspondence Address: GREGORY D. KENDRA, 11450 MARKS DR., CONIFER, CO, 80433, US

(21) Appl. No.: 12/800,664

(22) Filed: May 20, 2010

Related U.S. Application Data
(60) Provisional application No. 61/268,006, filed on Jun. 8, 2009.

(51) Int. Cl. B27K 5/00

(52) U.S. Cl. 62/62

(57) ABSTRACT

A cryogenic treatment for wooden baseball bats to provide a new, cryogenically treated wooden baseball bat that has many of the advantages of the traditional and alternative material bats mentioned heretofore, but with a significant novel feature, that of having been cryogenically treated. The result is a new, cryogenically treated wooden baseball bat which is not anticipated, rendered obvious, suggested, or even implied by any of the prior art, either alone or in combination thereof because cryogenic treatment is typically implemented upon metallic objects and not on wooden objects. The process relates to a process/method/system of manufacture wherein the same can be utilized for improving the strength of standard wooden baseball bats via cryogenic treatment, thereby reducing the occurrence of breakage of said bats. This is intended to increase the safety of players and fans through the reduced risk of being struck by sharply pointed projectiles/shrapnel that results when breakage does occur. The inventive process includes taking the standard produced wooden baseball bats and systematically and methodically processing said bat via a cryogenic process/treatment. Note that we are aware that a similar cryogenic process has been utilized with metallic baseball bats, but never, to our knowledge, has this process been attempted upon standard wooden baseball bats. The CK Process™ involves cryogenically treating (deep freezing) standard wooden baseball bats at a controlled time/temperature cycle, thereby altering the alignment of the internal molecular/crystalline lattice structure of the wood, thereby relieving the internal residual stresses of said wooden baseball bats, similar to the process of tempering metals. The CK Process™ in no way adversely alters the bat and the bat remains within the current regulations and specifications required under Major League Baseball RTM rule 1.10.

### CROSS REFERENCE TO RELATED APPLICATIONS

This application claims the benefit of PPA No. 61/268,006, filed Jun. 8, 2009 by the present inventors, which is incorporated herein by reference.

### BACKGROUND OF THE INVENTION

1. Field of the Invention

The present invention relates generally to CK Process™/Super Bat™ and more specifically, it relates to a cryogenic treatment for wooden baseball bats to provide a new, cryogenically treated wooden baseball bat that has many of the advantages of the traditional and alternative material bats mentioned heretofore, but with a significant novel feature, that of having been cryogenically treated. The result is a new, cryogenically treated wooden baseball bat which is not anticipated, rendered obvious, suggested, or even implied by any of the prior art, either alone or in combination thereof because cryogenic treatment is typically implemented upon metallic objects and not on wooden objects. It relates to a process/method/system of manufacture wherein the same can be utilized for improving the strength of standard wooden baseball bats via cryogenic treatment, thereby reducing the occurrence of breakage of said bats. This is intended to increase the safety of players and fans through the reduced risk of being struck by sharply pointed projectiles/shrapnel that results when breakage does occur.

2. Description of the Prior Art

It can be appreciated that standard wooden baseball bats have been in use for years. Typically, standard baseball bats are comprised of a single piece of wood, generally from the group of woods consisting of ash, maple hickory, oak, birch, beech or elm. Leagues other than Major League Baseball® utilize bats of various materials including: aluminum, graphite, carbon, composites, etc. These alternative materials are not acceptable for use in Major League Baseball®. One might refer to U.S. Pat. Nos. 7,410,433 (bat handle with optimal dampening) and 7,448,971 (reinforced wooden baseball bat) to see efforts to advance the existing state of the art.

The main problem with conventional bats and of conventional bats made of materials other than wood and of the previously described designs are that they are not acceptable under and within the rules and specifications of various leagues. Another problem with conventional, standard wooden baseball bats is that they do not have the durability and strength to withstand high energy forces (especially associated with fast pitch hardball) and upon fracture/failure become a dangerous hazard with sharply pointed projectiles/shrapnel, which endanger players and fans. Another problem with conventional, standard wooden baseball bats is that other variations incorporate structural alteration of the bat which utilizes materials outside of the scope of currently acceptable regulations and specifications, specifically per Major League Baseball® rule 1.10.

While these devices may be suitable for the particular purpose to which they address, they are not as suitable to provide a process/method/system of manufacture to produce a new, cryogenically treated wooden baseball bat that has many of the advantages of the traditional and alternative material bats mentioned heretofore, but with a significant novel feature, that of having been cryogenically treated. The result is a new, cryogenically treated wooden baseball bat which is not anticipated, rendered obvious, suggested, or even implied by any of the prior art, either alone or in combination thereof because cryogenic treatment is typically implemented upon metallic objects and not on wooden objects. This method relates to a process/method/system of manufacture wherein the same can be utilized for improving the strength of standard wooden baseball bats via cryogenic treatment, thereby reducing the occurrence of breakage of said bats. This is intended to increase the safety of players and fans through the reduced risk of being struck by sharply pointed projectiles/shrapnel that results when breakage does occur. The main problem with conventional bats made of materials other than wood and of the previously described designs are that they are not acceptable under and within the rules and specifications of various leagues. Another problem is conventional, standard wooden baseball bats do not have the durability and strength to withstand high energy forces (especially associated with fast pitch hardball) and upon fracture/failure become a dangerous hazard with sharply pointed projectiles/shrapnel which endanger players and fans. Also, another problem is conventional, standard wooden baseball bats with other variations incorporate structural alteration of the bat which utilizes materials outside of the scope of currently acceptable regulations and specifications, specifically per Major League Baseball® rule 1.10.

In these respects, the cryogenic treatment for wooden baseball bats according to the present invention substantially departs from the conventional concepts and designs of the prior art, and in so doing utilizes an apparatus which provides a new, cryogenically treated wooden baseball bat that has many of the advantages of the traditional and alternative material bats mentioned heretofore, but with a significant novel feature, that of having been cryogenically treated. The result is a new, cryogenically treated wooden baseball bat which is not anticipated, rendered obvious, suggested, or even implied by any of the prior art, either alone or in combination thereof because cryogenic treatment is typically implemented upon metallic objects and not on wooden objects.

This method relates to a process/method/system of manufacture wherein the same can be utilized for improving the strength of standard wooden baseball bats via cryogenic treatment, thereby reducing the occurrence of breakage of said bats. This is intended to increase the safety of players and fans through the reduced risk of being struck by sharply pointed projectiles/shrapnel that results when breakage does occur.

### SUMMARY OF THE INVENTION

In view of the foregoing disadvantages inherent in the known types of untreated standard conventional wooden baseball bats and bats made of alternative materials now present in the prior art, the present invention provides a new process/method/system of cryogenic treatment for wooden baseball bats wherein the same can be utilized to provide a new, cryogenically treated wooden baseball bat that has many of the advantages of the traditional and alternative material bats mentioned heretofore, but with a significant novel feature, that of having been cryogenically treated. The result is a new, cryogenically treated wooden baseball bat which is not anticipated, rendered obvious, suggested, or even implied by any of the prior art, either alone or in combination thereof, because cryogenic treatment is typically implemented upon metallic objects and not on wooden objects. This method relates to a process/method/system of manufacture wherein the same can be utilized for improving the strength of standard wooden baseball bats via cryogenic treatment, thereby reducing the occurrence of breakage of said bats. This is intended to increase the safety of players and fans through the reduced risk of being struck by sharply pointed projectiles/shrapnel that results when breakage does occur.

The general purpose of the present invention, which will be described subsequently in greater detail, is to provide a new cryogenic treatment for wooden baseball bats that has many of the advantages of the traditional and alternative material bats mentioned heretofore and many novel features that result in a new cryogenic treatment for wooden baseball bats which is not anticipated, rendered obvious, suggested, or even implied by any of the prior art, either alone or in any combination thereof, because cryogenic treatment is typically implemented upon metallic objects and not on wooden objects.

To attain this, the present invention generally comprises taking the standard produced wooden baseball bats and systematically and methodically processing said bats via a cryogenic process/treatment. Note that we are aware that a similar cryogenic process has been utilized with metallic baseball bats, but never, to our knowledge, has this process been attempted upon standard wooden baseball bats. The CK Process™ involves cryogenically treating (deep freezing) standard wooden baseball bats at a controlled time/temperature cycle, thereby altering the alignment of the internal molecular/crystalline lattice structure of the wood, thereby relieving the internal residual stresses of said wooden baseball bats, similar to the process of tempering metals. The CK Process™ in no way adversely alters the bat and the bat remains within the current regulations and specifications required under Major League Baseball® rule 1.10.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the process/method/system of manufacture set forth in the following description. The invention is capable of other embodiments and of being practiced and carried out in various ways. Also, it is to be understood that the phraseology and terminology employed herein are for the purpose of the description and should not be regarded as limiting.

A primary object of the present invention is to provide a cryogenic treatment for wooden baseball bats that will overcome the shortcomings of the prior art devices.

An object of the present invention is to provide a cryogenic treatment for wooden baseball bats to provide a system/method/process of manufacture resulting in a new, cryogenically treated wooden baseball bat that has many of the advantages of the traditional and alternative material bats mentioned heretofore, but with a significant novel feature, that of having been cryogenically treated. The result is a new, cryogenically treated wooden baseball bat which is not anticipated, rendered obvious, suggested, or even implied by any of the prior art, either alone or in combination thereof because cryogenic treatment is typically implemented upon metallic objects and not on wooden objects. This process relates to a process/method/system of manufacture wherein the same can be utilized for improving the strength of standard wooden baseball bats via cryogenic treatment, thereby reducing the occurrence of breakage of said bats. This is intended to increase the safety of players and fans through the reduced risk of being struck by sharply pointed projectiles/shrapnel that results when breakage does occur.

Another object is to provide a cryogenic treatment for wooden baseball bats that provides a cryogenically treated wooden baseball bat which will overcome the shortcomings of the prior art devices. Also, to provide a cryogenically treated wooden baseball bat by providing a system/method/process of manufacture wherein the same can be utilized for improving the strength of standard wooden baseball bats, thereby reducing the occurrence of breakage of said bats. This is intended to increase the safety of players and fans through reduced risk of being struck by sharply pointed projectiles/shrapnel that results when bat breakage does occur.

Another object is to provide a cryogenic treatment for wooden baseball bats that provides a cryogenically treated wooden baseball bat which is within the current and reasonably anticipated future rules, regulations and specifications of various leagues, especially those of Major League Baseball®.

Another object is to provide a cryogenic treatment for wooden baseball bats that provides a cryogenically treated wooden baseball bat that has been processed via a system/method/process/treatment that significantly increases the strength and durability of standard wooden baseball bats.

Another object is to provide a cryogenic treatment for wooden baseball bats that provides a cryogenically treated wooden baseball bat that reduces the likelihood of fracture/failure of standard wooden baseball bats.

Another object is to provide a cryogenic treatment for wooden baseball bats that provides a cryogenically treated wooden baseball bat which significantly reduces the danger to both players and fans resulting from wooden baseball bat failure/fracture/breakage with associated sharp, pointed projectiles/shrapnel.

Other objects and advantages of the present invention will become obvious to the reader and it is intended that these objects and advantages are within the scope of the present invention.

To the accomplishment of the above and related objects, this invention may be embodied in the form described in the accompanying description, attention being called to the fact, however, that the descriptions are illustrative only, and that changes may be made in the specific process illustrated.

### BRIEF DESCRIPTION OF THE DRAWINGS

Not Applicable—as this process involves physically transforming the internal structure of the wooden baseball bats and has no parts to further describe.

### DESCRIPTION OF THE PREFERRED EMBODIMENT

Turning now to the description of a cryogenic treatment for wooden baseball bats, which comprises taking the standard produced wooden baseball bats and systematically and methodically processing said bat via a cryogenic process/treatment. Note that we are aware that a similar cryogenic process has been utilized with metallic baseball bats, but never, to our knowledge, has this process been attempted upon standard wooden baseball bats. The CK Process™ involves cryogenically treating (deep freezing) standard wooden baseball bats at a controlled time/temperature cycle, thereby altering the alignment of the internal molecular/crystalline lattice structure of the wood, thereby relieving the internal residual stresses of said wooden baseball bats, similar to the process of tempering metals. The CK Process™ in no way adversely alters the bat and the bat remains within the current regulations and specifications required under Major League Baseball® rule 1.10

A cryogenically treated wooden baseball bat is produced via a system/method/process of manufacture wherein the same can be utilized for improving the strength of standard wooden baseball bats and thereby reducing the occurrence of breakage of said bats. This is intended to increase the safety of players and fans through reduced risk of being struck by sharply pointed projectiles/shrapnel which results when breakage does occur. The invention includes taking standard produced wooden baseball bats and systematically and methodically processing said bats via a cryogenic process/method/system/treatment. The standard wooden baseball bat is contained within and processed via a deep freeze treatment within a cryogenic chamber apparatus and is physically transformed, whereby likelihood of dangerous bat breakage is reduced.

Other than internal alteration of the structural alignment and density at the microscopic level, there are no interconnections regarding this process, but alternative variations of the process are discussed elsewhere in this application.

A standard wooden baseball bat or bats (with particular emphasis on maple bat construction) is/are deposited into an insulated and controlled cryogenic chamber apparatus (such as that of Cryogenics International of Scottsdale, Ariz.). The process utilizes vaporous or gaseous nitrogen (or other suitable cryogenic gases) whereby air and moisture is purged from the treatment chamber and temperature is slowly and precisely lowered over at least an eight hour period to temperatures at least as low as −310 degrees Fahrenheit. The bat is held at this “soak temperature” for a period of at least 24 hours to assure maximum penetration of the entire mass. The return to ambient temperature is also at a slow, predetermined increasing temperature rate, with ascent over at least a twelve hour period, in equal temperature increments. Initial Modulus of Rupture testing by an independent university laboratory (processing and testing having been accomplished without participant's knowledge of end product use) comparing treated to untreated specimens resulted in an approximate 26% increase improvement of initial failure level for the control versus the test specimens. We are aware that standard wooden baseball bats represent a statistically based product which has much variation, based upon its many variables, including: wood quality (i.e. old growth versus new, fast growth) geographically resultant moisture content, weight, length, shape (i.e. barrel versus handle) and directional cut in relation to wood grain. We intend to extend the above described process to include all wood types, various methods of deep freezing and all various combinations of time/temperature/initial moisture content to arrive at an optimal combination(s).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation described, and accordingly, all suitable modifications and equivalents may be resorted to, falling within the scope of the invention.

We claim:

1. A method whereby a standard wooden baseball bat or bats is or are contained within and processed via treatment within a cryogenic chamber apparatus at a predetermined time and temperature and is or are physically transformed resulting in reducing the likelihood of dangerous bat breakage.
